(19) United States
(12) Patent Application Publication
(10) Pub. No.: US 2019/0286582 A1
(43) Pub. Date: Sep. 19, 2019

(54) METHOD FOR PROCESSING CLIENT REQUESTS IN A CLUSTER SYSTEM, A METHOD AND AN APPARATUS FOR PROCESSING I/O ACCORDING TO THE CLIENT REQUESTS

(71) Applicant: Apposha Co., Ltd., Seoul (KR)

(72) Inventors: Sang Wook KIM, Hwaseong-si (KR); Byeong Hun HYEON, Suwon-si (KR)

(73) Assignee: Apposha Co., Ltd., Seoul (KR)

(21) Appl. No.: 16/427,799

(22) Filed: May 31, 2019

Related U.S. Application Data
(62) Division of application No. 15/922,442, filed on Mar. 15, 2018.

(30) Foreign Application Priority Data
May 8, 2017 (KR) 10-2017-0057337

(51) Int. Cl. G06F 13/16; G06F 13/10; G06F 13/20

(52) U.S. Cl. CPC G06F 13/1642; G06F 13/1626; G06F 13/1689; G06F 13/102; G06F 13/20; G06F 13/1673

(57) ABSTRACT

A method is provided for processing I/O via an I/O processing apparatus. The method includes at least: receiving a first I/O request being classified as a critical I/O, and a second I/O request being classified as a non-critical I/O; assigning a higher priority than the second I/O request to the first I/O request; and processing the first and second I/O requests on the basis of the assigned priority. The processing the first and second I/O requests includes: detecting that a processing state of the first I/O request is changed to a standby state by processing of the second I/O request; reclassifying the second I/O request as the critical I/O; and changing the priority of the second I/O request to the priority of the first I/O request in response to the detecting and processing the second I/O request on the basis of the changed priority of the second I/O request.

### CROSS-REFERENCE TO RELATED APPLICATIONS

This application is a Divisional of U.S. patent application Ser. No. 15/922,442 filed on Mar. 15, 2018, which claims priority from Korean Patent Application No. 10-2017-0057337 filed on May 8, 2017 in the Korean Intellectual Property Office, the disclosure of which is incorporated herein by reference in its entirety.

### FIELD OF TECHNOLOGY

The present disclosure relates to a method for processing client requests in a cluster system, and a method and an apparatus for processing I/O issued in accordance with client requests. More specifically, the present disclosure relates to a method for processing client requests for improving a response time in a cluster system constituted by a plurality of nodes, and a method and an apparatus for improving an I/O throughput and a response time of a foreground task for processing the client requests.

### BACKGROUND

Data-intensive applications such as a database management system (DBMS) serve to safely store and efficiently provide user's data. In order to effectively perform such a role, the data-intensive applications execute a foreground task (1) that processes the user's request, and a background task (2) that executes works such as checkpoint and data defragmentation in the background, in parallel. However, it is known that the aforementioned background task causes a problem of delaying the I/O processing of the foreground task generated in the course of processing the client requests to remarkably lower the user's perceived performance.

For example, in the case of processing the foreground task and the checkpoint task in parallel, using a CFQ (completely fair queuing)-based I/O scheduler as illustrated in FIG. 2, it can be seen that the throughput of the foreground task greatly decreases for each time when the checkpoint task is periodically performed. Such a phenomenon occurs similarly not only in CFQ but also in the latest I/O scheduler such as Split-AFQ, and Split-Deadline.

The phenomenon of performance degradation of the foreground task is largely caused by two problems.

A first problem is a problem in which the priorities of I/O requested by foreground tasks are not reflected in all the layers existing on the I/O path. In order to provide convenience of understanding, this problem will be explained with reference to FIGS. 3A and 3B.

Referring to FIGS. 3A and 3B, the layers existing on the I/O path in which I/O requests are processed may be largely abstracted into a caching layer 10, a file system layer 20, and a block layer 30. Among them, in a case where the buffer cache 11 includes a dirty page of a critical ratio or more due to the I/O request of the background task, in the caching layer 10, the I/O request of the foreground task may be delayed in buffer page allocation regardless of priority. Also, in the block layer 30, when the I/O request of the background task satisfies an I/O wait queue 31, the processing of the I/O request of the foreground task may be delayed irrespective of the priority. On the other hand, since the I/O order may also be reordered the internal queue 41 of the storage device irrespective of the priority in order to improve the I/O performance, the I/O processing of the foreground task may be delayed due to I/O of the background task. In this way, on the whole I/O path, the I/O request of the foreground task may be delayed by the I/O request of the background task despite the higher priority.

A second problem is a problem related to a phenomenon of the I/O priority inversion which may be caused by the synchronization processing between the foreground task and the background task. For example, as illustrated in FIG. 4, when the synchronization processing is performed, using synchronization primitives 51 to 53 of a user level or a kernel level such as a mutex, a condition variable, and a semaphore, there arises a problem that the I/O processing of the foreground task is delayed due to the background task entering the critical section first.

Therefore, even if a higher priority is given to the foreground task, a performance problem occurs due to the background task, and there is a need for a method for processing I/O for solving the above-mentioned problem.

### SUMMARY

An aspect of the present disclosure provides a method and an apparatus for processing I/O capable of improving an I/O throughput and a response time of a foreground task for processing client requests.

Another aspect of the present disclosure provides a method and an apparatus for processing I/O which ensure I/O priority of foreground task in all layers on the I/O path.

Still another aspect of the present disclosure provides a method and an apparatus for processing I/O capable of minimizing a delay time of processing of an I/O request of a foreground task in accordance with a phenomenon of the I/O priority inversion.

Still another aspect of the present disclosure provides a method for processing client requests capable of improving the average response time of many client requests in a cluster system including a plurality of nodes.

According to an embodiment of the present disclosure, there is provided a method for processing I/O, via an I/O processing apparatus. The method comprises receiving a first I/O request and a second I/O request, the first I/O request being classified as a critical I/O, and the second I/O request being classified as a non-critical I/O, assigning a higher priority than the second I/O request to the first I/O request and processing the first I/O request and the second I/O request on the basis of the assigned priority, wherein the processing the first I/O request and the second I/O request comprises detecting that a processing state of the first I/O request is changed to a standby state by processing of the second I/O request, reclassifying the second I/O request as the critical I/O, and changing the priority of the second I/O request to the priority of the first I/O request in response to the detecting and processing the second I/O request on the basis of the changed priority of the second I/O request.

According to another embodiment of the present disclosure, there is provided a method for processing client request executed in a cluster system including a plurality of nodes. The method comprises tagging a request identifier to the client request in accordance with a processing order of the client request in response to receiving the client request, forwarding a first sub-request derived from the client request to a first node of the plurality of nodes, and forwarding a second sub-request derived from the client request to a second node of the plurality of nodes, the request identifier being tagged to each of the first sub-request and the second sub-request, processing a first I/O request generated in accordance with the first sub-request, depending on the processing order of the request identifier tagged to the first sub-request, at the first node and processing a second I/O request generated in accordance with the second sub-request, depending on the processing order of the request identifier tagged to the second sub-request, at the second node.

According to still another embodiment of the present disclosure, there is provided an apparatus for processing I/O. The apparatus comprises a hardware processor, a memory configured to load a computer program executed by the hardware processor and a storage configured to store the computer program, wherein the computer program which, when executed by the hardware processor, causes the hardware processor to perform operations comprising receiving a first I/O request and a second I/O request, the first I/O request being classified as a critical I/O, and the second I/O request being classified as a non-critical I/O, assigning a priority higher than the second I/O request to the first I/O request and processing the first I/O request and the second I/O request on the basis of the assigned priority, wherein the processing the first I/O request and the second I/O request comprises detecting that a processing state of the first I/O request is changed to a standby state by processing of the second I/O request, reclassifying the second I/O request to the critical I/O, and changing the priority of the second I/O request to the priority of the first I/O request in response to the detecting the change of the processing state of the first I/O request, and processing the second I/O request on the basis of the changed priority of the second I/O request.

According to still another embodiment of the present disclosure, there is provided a non-transitory computer-readable storage medium storing a computer program which, when executed by a computing apparatus, causes the computing apparatus to perform receiving a first I/O request and a second I/O request, the first I/O request being classified as a critical I/O, and the second I/O being classified as a non-critical I/O, assigning a higher priority than the second I/O request to the first I/O request and processing the first I/O request and the second I/O request on the basis of the assigned priority, wherein the processing the first I/O request and the second I/O request comprises detecting that a processing state of the first I/O request is changed to a standby state by processing of the second I/O request, reclassifying the second I/O request as the critical I/O, and changing the priority of the second I/O request to the priority of the first I/O request in response to the detecting and processing the second I/O request on the basis of the changed priority of the second I/O request.

The aspects of the present disclosure are not limited to those mentioned above, and another aspect which has not been mentioned will be clearly understood to ordinary technicians in the technical field of the present disclosure from the description below.

According to the present disclosure described above, there is an effect in which the I/O throughput of the foreground task is greatly improved, and the response delay due to the background task is improved.

Specifically, a buffer cache is allocated to the critical I/O and non-critical I/O type I/O requests in the caching layer, using different threshold values. Accordingly, there is an effect of preventing the I/O processing of the foreground task from being delayed due to the background task in the caching layer.

Also, different I/O wait queues are allocated to critical I/O and non-critical I/O type I/O requests in the block layer, and an I/O wait queue in which the critical I/O type I/O requests are queued is processed preferentially. Accordingly, there is an effect of preventing the I/O processing of the foreground task from being delayed due to the background task in the block layer.

In addition, in the case where a phenomenon of priority inversion due to task dependency occurs, by allowing the background task to quickly escape from the critical section via priority inheritance, the waiting time of the foreground task can be minimized. Accordingly, there is an effect of preventing the I/O processing of the foreground task from being delayed due to the synchronization processing with the background task.

In addition, when the phenomenon of priority inversion due to I/O dependency occurs, by processing the non-critical I/O type I/O quickly via priority inheritance, there is an effect of minimizing waiting time of the critical I/O type I/O.

According to the present disclosure described above, in the cluster system including the plurality of nodes, by giving a global request identifier in the order of client requests, I/O scheduling is performed on the basis of the processing order of the client requests at all the nodes. Thus, it is possible to improve the average response time of multiple client requests.

Further, in the case where the present disclosure is applied to a game service or the like sensitive to response delay, it is possible to provide an improved user experience to the end user in accordance with improvement of the average response time.

The effects of the present disclosure are not limited to the effects mentioned above, and another effect which has not been mentioned can be clearly understood by ordinary technicians from the following description.

### BRIEF DESCRIPTION OF THE DRAWINGS

The above and other aspects and features of the present disclosure will become more apparent by describing in detail exemplary embodiments thereof with reference to the attached drawings, in which:

FIGS. 1 and 2 are diagrams for explaining a problem in which I/O processing performance of a foreground task is degraded due to a background task;

FIGS. 3A and 3B are diagrams for explaining a problem in which the I/O priority of the foreground task is not reflected on the I/O path;

FIG. 4 is a diagram for explaining a problem in which the I/O processing of the foreground task is delayed in accordance with the phenomenon of priority inversion;

FIGS. 5A and 5B are diagrams for explaining an exemplary system to which the present disclosure can be applied;

FIG. 6 is a hardware configuration diagram of an I/O processing apparatus according to an embodiment of the present disclosure;

FIGS. 7 to 8B are diagrams for explaining a method for classifying the type of I/O request that can be referred to in some embodiments of the present disclosure;

FIG. 9 is a diagram for explaining an method for processing I/O in a caching layer that can be referred to in some embodiments of the present disclosure;

FIG. 10 is a diagram for explaining a method for processing I/O in the block layer that can be referred to in some embodiments of the present disclosure;

FIGS. 11 and 12 are diagrams for explaining a processing method according to I/O dependency which can be referred to in some embodiments of the present disclosure;

FIGS. 13A and 13B are diagrams for explaining a processing method according to the task dependency which can be referred to in some embodiments of the present disclosure;

FIGS. 14A and 14B are diagrams for explaining a processing method according to the transition dependency which can be referred to in some embodiments of the present disclosure;

FIGS. 15A and 15B are diagrams for explaining the performance test results of the method for processing I/O according to another embodiment of the present disclosure;

FIG. 16 is a diagram for explaining an exemplary cluster system to which the present disclosure can be applied;

FIGS. 17A and 17B are diagrams for explaining the problem of delay of the average response time of the client requests in the cluster system;

FIG. 18 is a diagram for explaining a method for processing client requests in the cluster system according to another embodiment of the present disclosure; and

FIG. 19 is a diagram for explaining the performance test results of the method for processing client requests in the cluster system according to still another embodiment of the present disclosure.

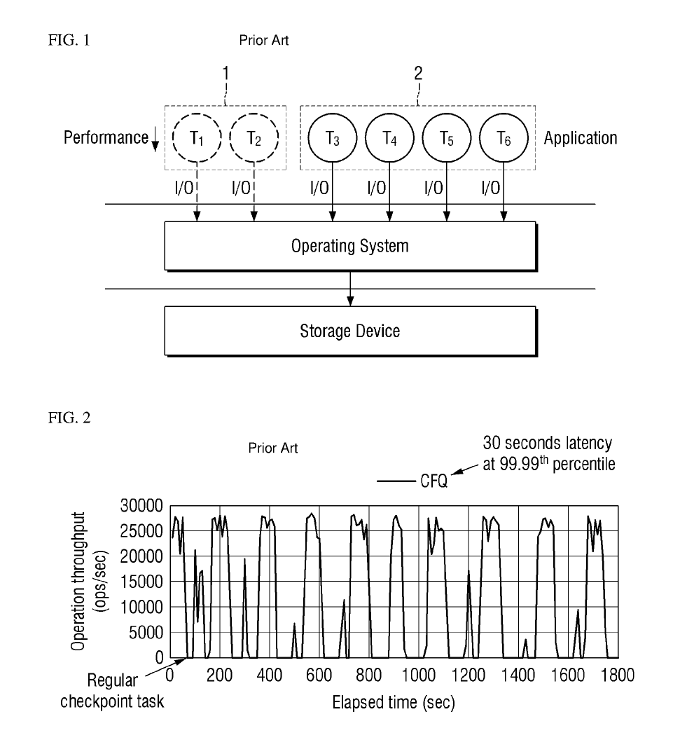

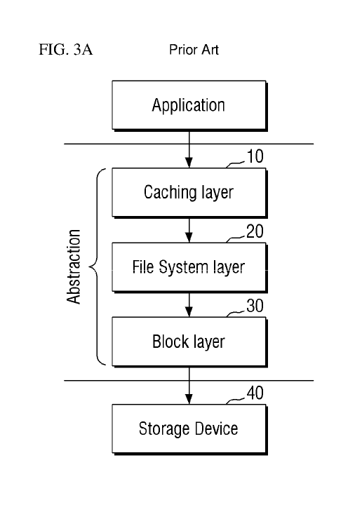

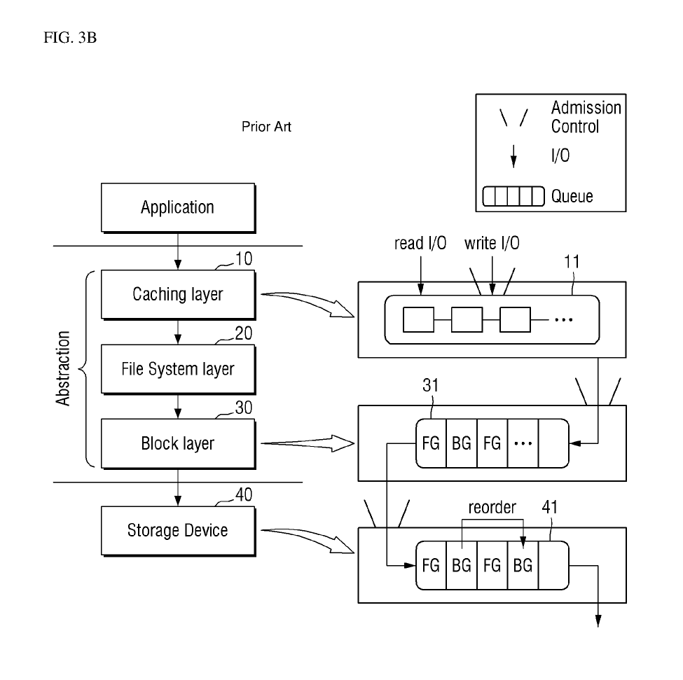

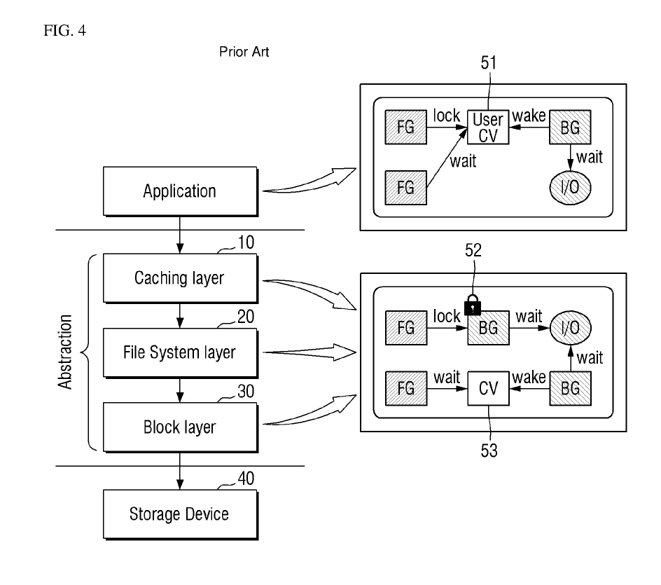

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims. Like numbers refer to like elements throughout.

Unless otherwise defined, all terms including technical and scientific terms used herein have the same meaning as commonly understood by one of ordinary skill in the art to which this disclosure belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described with reference to the drawings.

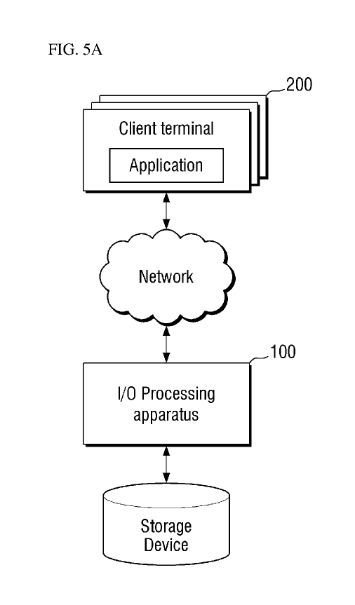

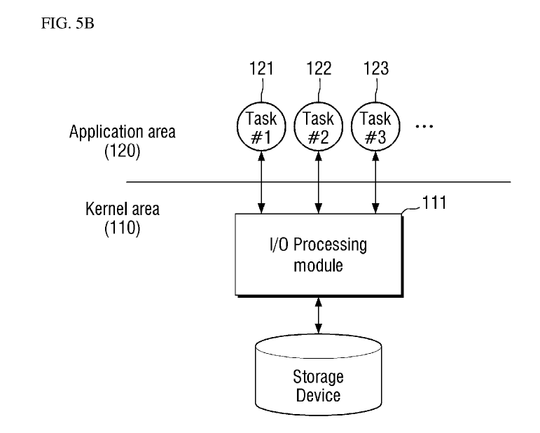

FIGS. 5A and 5B are diagrams for explaining an exemplary system to which the present disclosure can be applied.

Referring to FIG. 5A, the above exemplary system may include an I/O processing apparatus 100, and a plurality of client terminals 200. However, this is only a preferred embodiment for achieving the object of the present disclosure, and some components may, of course, be added or removed as necessary.

In the aforementioned exemplary system, the plurality of client terminals 200 is a computing device which transmits client requests including a query of specific data to the I/O processing apparatus 100 to receive various kinds of data stored in a storage device.

In the aforementioned exemplary system, the I/O processing apparatus 100 is a computing device that processes a plurality of I/O generated in accordance with client requests received from the plurality of client terminals 200. For example, the I/O processing apparatus 100 may be a computing device that manages a data intensive application such as a DBMS. Here, the computing device may be a notebook, a desktop, a laptop, etc. However, the computing device may be desirable to be provided as a high performance server device. However, the above-described computing device is not limited to the form of the device, but may include all kinds of devices provided with computing means and communication means.

As illustrated in FIG. 5B, the I/O processing apparatus 100 may execute a plurality of foreground tasks 121 to 123 in order to process client requests. The foreground tasks 121 to 123 generate at least one I/O request to process the client requests. The foreground tasks 121 to 123 generate at least one I/O request to process the client requests, and the I/O request is processed in the I/O processing module 111. For reference, in the present specification, the foreground task means a task for processing tasks related to the client requests, and the task refers to a single work unit, and may be provided as, for example, at least one thread or process, and the single application may include at least one task.

In the above-described exemplary system, the I/O processing apparatus 100 may execute the background task for executing the work irrelevant to a request of a client terminal, such as a checkpoint and a data fragmentation other than a foreground task, in parallel. Therefore, as described above, there may be a problem in which the processing of the foreground task is delayed in accordance with the execution of the background task.

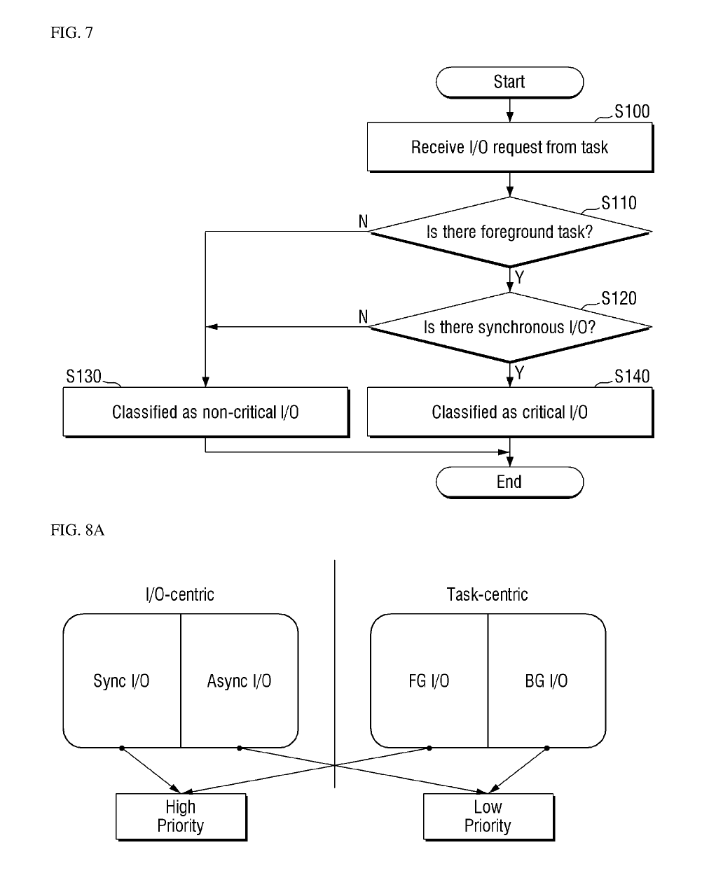

According to the embodiment of the present disclosure, the I/O processing module 111 inside the I/O processing apparatus 100 performs the process so that the I/O priority of the foreground task in the caching layer and the block layer existing on the I/O path is kept to be higher than the priority of the I/O of the background task in order to prevent the processing of the foreground task from being delayed due to the processing of the background task. Further, when a reversal phenomenon of I/O priority is detected between the foreground task and the background task or between the I/O request of the foreground task and the I/O request of the background task, the I/O processing module 111 quickly processes the I/O requests of background tasks and background tasks via priority inheritance. As a result, it is possible to ensure that the I/O throughput and the response speed of the foreground task do not decrease even if the I/O load of the background task increases. Specific contents of the method for processing I/O executed by the I/O processing apparatus 100 or the I/O processing module 111 will be described in detail with reference to FIGS. 7 to 14B.

In the aforementioned exemplary system, a plurality of client terminals 200 and the I/O processing apparatus 100 may communicate with each other via a network. Here, the network may be provided as all types of wired/wireless networks such as a local area network (LAN), a wide area network (WAN), a mobile radio communication network, and wireless broadband Internet (Wibro).

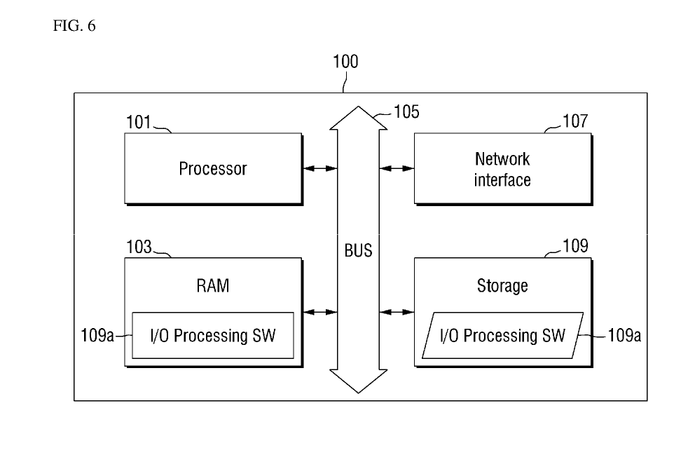

Heretofore, the configuration of an exemplary system to which the present disclosure can be applied has been described referring to FIGS. 5A and 5B. Next, the configuration and operation of the I/O processing apparatus 100 according to one embodiment of the present disclosure will be described with reference to FIG. 6.

FIG. 6 is a hardware configuration diagram of the I/O processing apparatus 100 according to an embodiment of the present disclosure.

Referring to FIG. 6, the I/O processing apparatus 100 may include one or more processors 101, a bus 105, a network interface 107, a memory 103 which loads computer programs executed by the processor 101, and a storage 109 which stores the I/O processing software 109a. However, only the components associated with the embodiment of the present disclosure are illustrated in FIG. 6. Therefore, a person having an ordinary skill in the art to which the present disclosure belongs can understand that other general-purpose components may be further included in addition to the components illustrated in FIG. 6.

The processor 101 controls the overall operation of each component of the I/O processing apparatus 100. The processor 101 may be configured to include a CPU (Central Processing Unit), a MPU (Micro Processor Unit), a MCU (Micro Controller Unit), a GPU (Graphic Processing Unit), or any type of processor well known in the technical field of the present disclosure. Further, the processor 101 may execute the operation of at least one application or program for executing the method according to the embodiment of the present disclosure. The I/O processing apparatus 100 may include one or more processors.

The memory 103 stores various types of data, commands, and/or information. The memory 103 may load one or more programs 109a from the storage 109 in order to execute the method for processing I/O according to the embodiment of the present disclosure. In FIG. 7, a RAM is illustrated as an example of a memory 103.

The bus 105 provides a communication function between the components of the I/O processing apparatus 100. The bus 105 may be provided as various forms of bus such as an address bus, a data bus, and a control bus.

The network interface 107 supports wired/wireless Internet communication of the I/O processing apparatus 100. Also, the network interface 107 may support various communication methods other than the Internet communication. To this end, the network interface 107 may be configured to include a communication module well-known in the technical field of the present disclosure.

The storage 109 may non-temporarily store one or more programs 109a. In FIG. 7, I/O processing software 109a is illustrated as an example of one or more programs 109a.

The storage 109 may be configured to include a nonvolatile memory such as a ROM (Read Only Memory), an EPROM (Erasable Programmable ROM), an EEPROM (Electrically Erasable Programmable ROM) and a flash memory, a hard disk, a removable disk, or a computer-readable recording medium of any form well-known in the technical field to which the present disclosure belongs.

According to the embodiment of the present disclosure, the I/O processing software 109a may perform the process so that the priority of the I/O request of the foreground task is kept to be higher than the priority of the I/O request of the background task over the entire I/O path. Further, the I/O processing software 109a may perform the process so that the priority of the background task may be temporarily changed to be high, when the phenomenon of the priority inversion is detected.

Specifically, the I/O processing software 109a may include an operation which is loaded to the memory 103 and receives the first I/O request and the second I/O request by one or more processors 101, the first I/O request being classified as critical I/O and the second I/O request being classified as non-critical I/O, an operation for giving a higher priority to the first I/O request than the second I/O request, an operation for processing the first I/O request and the second I/O request on the basis of the priority, an operation for detecting that the processing state of the first I/O request is changed to a standby state by processing of the second I/O request, an operation for reclassifying the type of second I/O request into critical I/O and changing the priority of the second I/O to the priority of the first I/O request in response to detection of the change of the processing state of the first I/O request, and an operation for processing the second I/O request on the basis of the priority of the changed second I/O request.

The configuration and operation of the I/O processing apparatus 100 according to the embodiment of the present disclosure has been described with reference to FIG. 6. Next, a method for processing I/O according to another embodiment of the present disclosure will be described in detail with reference to FIGS. 7 to 14B.

Each step of the method for processing I/O according to an embodiment of the present disclosure can be executed by a computing device. For example, the above-described computing device may be an I/O processing apparatus 100 according to an embodiment of the present disclosure. For the sake of convenience of explanation, however, the subject of each operation included in the method for processing I/O may be omitted. On the other hand, each step of the method for processing I/O may be an operation executed by the I/O processing apparatus 100 by executing the I/O processing software 109a through the processor 101.

In the method for processing I/O according to the embodiment of the present disclosure, the type of I/O request is classified as one of the critical I/O or the non-critical I/O, and the critical I/O is processed with higher priority than non-critical I/O over the entire I/O path. Hereinafter, for convenience of understanding, it is assumed that all of the I/O requests classified as the critical I/O or the I/O requests classified as the non-critical I/O have the same priority. However, it is a matter of course that different priority may be given for each I/O request classified as critical I/O or each I/O request classified as non-critical I/O.

FIG. 7 is a flow chart of the type classification method for the I/O request that can be referred to in some embodiments of the present disclosure. However, this is only the preferred embodiment for achieve the object of the present disclosure, and some steps may, of course, be added or removed as necessary.

Referring to FIG. 7, the I/O processing apparatus 100 receives an I/O request from a task which is being executed in an application region or a kernel region (S100). When the I/O request is received, the I/O processing apparatus 100 determines whether or not the requested task that transmits the I/O request corresponds to a foreground task (S110).

In an embodiment, flag information indicating whether the requested task corresponds to the foreground task may be explicitly set by the requested task. For example, flag information indicating that the requested task is a foreground task may be set by an API (application programming interface) called by the above-described requested task. In such a case, the I/O processing apparatus 100 may execute the determination step (S110) on the basis of the flag information.

In another embodiment, the I/O processing apparatus 100 may analyze the execution pattern of the requested task to determine whether the requested task corresponds to a foreground task. For example, when the requested task transmits an I/O request at a constant cycle, the I/O processing apparatus 100 may determine that the requested task corresponds to a background task. Generally, the reason is that background tasks execute the I/O processing work in accordance with the preset cycles.

In another embodiment, the I/O processing apparatus 100 may determine whether the requested task corresponds to a background task on the basis of the name of the requested task. For example, the I/O processing apparatus 100 may determine whether the requested task corresponds to a background task, by comparing the well-known threads such as the Journaling Block Device (JBD) 2 thread, and the well-known daemon process with the names of the requested tasks described above.

If the requested task is determined as the background task, the I/O processing apparatus 100 classifies the received I/O request as non-critical I/O (S130). On the other hand, if the requested task is determined as the foreground task, the I/O processing apparatus 100 classifies the received I/O request as critical I/O (S140). In some cases, the I/O processing apparatus 100 may classify the type of the received I/O request as critical I/O, only when the requested task is the foreground task and the received I/O request is synchronous I/O (S120, and S140). Here, the synchronous I/O refers to a function in which the requested task waits until the data is recorded on the storage device, such as an “fsync ( )” function. On the contrary, asynchronous I/O means I/O (e.g., buffered I/O) in which the I/O function is terminated as soon as data is written on buffer cache or the like, without waiting until the data is recorded on the storage device.

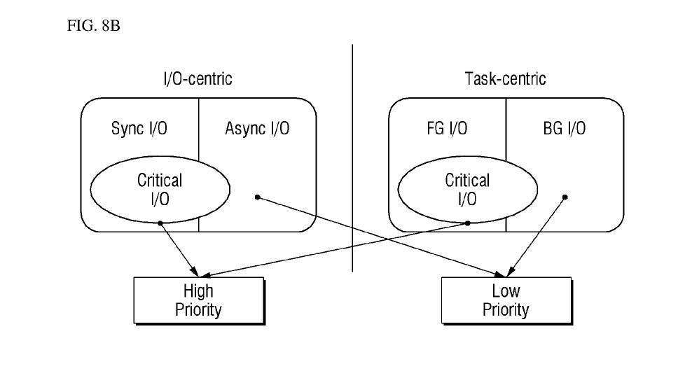

When the classification manner according to the embodiment of the present disclosure is compared to the conventional I/O classification manner, as illustrated in FIG. 8A, the conventional I/O classification is classified into synchronous I/O or asynchronous I/O on the basis of the type of I/O, or is classified into I/O of foreground task or I/O of background task on the basis of tasks, and the priorities assigned according to the above classification are fixed values which are not changed until the I/O processing is completed.

On the other hand, as illustrated in FIG. 8B, there is a difference in which the I/O classification according to the embodiment of the present disclosure is classified as critical I/O and non-critical I/O, and in some cases, the type of I/O and the priority may change. For example, although the I/O request of the foreground task is initially classified as critical I/O, the I/O request of the background task may also be temporarily reclassified as critical I/O via priority inheritance etc., and asynchronous I/O type may also be reclassified as critical I/O. An example in which the I/O request type of the background task is changed to the critical I/O through the priority inheritance will be described later.

In summary, the I/O processing apparatus 100 classifies the I/O request of the foreground task as critical I/O. Further, the I/O processing apparatus 100 processes the I/O request classified as critical I/O over the entire I/O path with higher priority than the I/O request classified as non-critical I/O. Thus, it is possible to avoid the problem in which the I/O throughput and the response speed of the foreground task are lowered due to the I/O processing of the background task. Hereinafter, for convenience of explanation, unless otherwise stated, the I/O request classified as critical I/O is referred to as “first type of I/O request” and the I/O request classified as non-critical I/O is referred to as “second type of I/O request”.

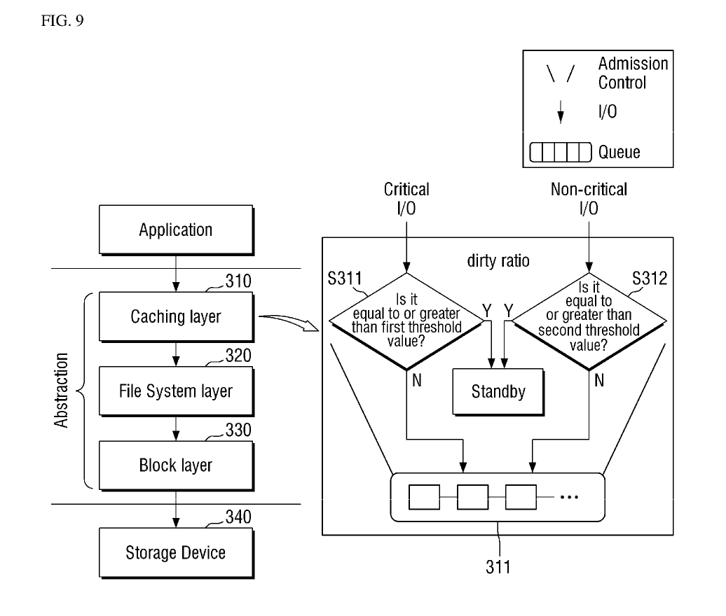

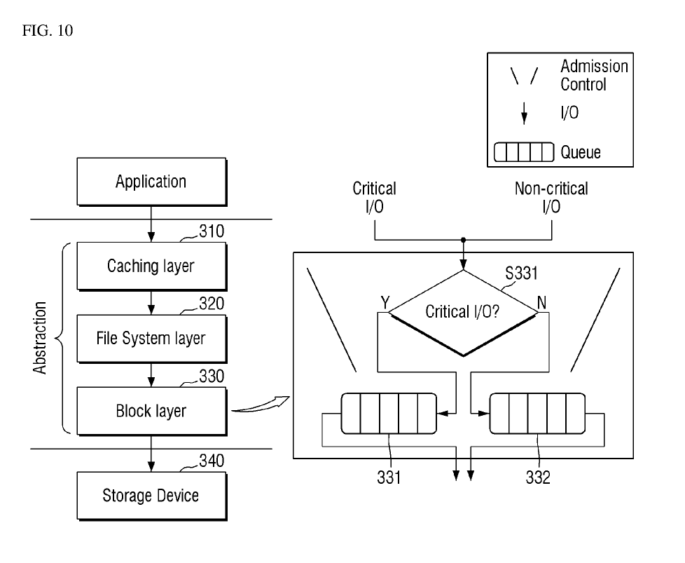

Hereinafter, a method for processing the first type of I/O request on the entire I/O path with high priority will be described with reference to FIGS. 9 to 10.

FIG. 9 is a diagram for explaining a method for processing I/O request in the caching layer 310 on the I/O path.

Referring to FIG. 9, in the caching layer, data associated with an I/O request is cached on the basis of a buffer cache. At this time, if the dirty page ratio is equal to or larger than the threshold value, since it is not possible to allocate the buffer page, the processing of the I/O request may be delayed until the buffer page can be allocated. Also, the delay is applied to all types of I/O requests, irrespective of the priority of I/O requests. Therefore, if the dirty page ratio of the buffer cache exceeds the threshold value due to a large number of I/O requests received from the background task, the I/O request of the foreground task may be delayed by the background task.

In order to solve the aforementioned problem, according to the embodiment of the present disclosure, threshold values individually set for each type of I/O request may be used. Specifically, the buffer pages can be allocated to the first type of I/O request, by comparing the first threshold value with the dirty page ratio of the buffer cache 311 (S311, and S313), and the buffer pages can be allocated to the second type of I/O request, by comparing the second threshold value with the dirty page ratio of the buffer cache (S312, and S313). Here, the second threshold value may be set to a value smaller than the first threshold value. By doing so, it is possible to prevent data according to the second type of I/O request from occupying most of the buffer cache in the caching layer 310.

However, according to another embodiment of the present disclosure, a separate buffer cache may be used for each type of I/O request. For example, the first type of I/O request may be cached via the first buffer cache, and the second type of I/O request may be provided to be cached via the second buffer cache. According to an embodiment, the first buffer cache and the second buffer cache may also refer to buffer pages that are logically distinguished in the same buffer cache. At this time, in the entire buffer page, the ratio occupied by the buffer page with respect to the first buffer cache may be a preset and fixed value, and may be a variation value which changes depending on the ratio occupied by the first type of I/O request in the entire I/O request.

Next, a method for processing I/O requests in the block layer 340 on the I/O path will be described with reference to FIG. 10.

Referring to FIG. 10, in the block layer, the I/O request is inserted into the I/O wait queue via an admission control stage in which inserting of the I/O wait queue is attempted. Also, I/O requests inserted into the I/O wait queue are dispatched to the storage device in accordance with the specified scheduling policy. At this time, when the I/O request of the background task satisfies the I/O wait queue, a problem may occur in which the I/O request of the foreground task is waited at the admission control stage.

In order to solve the aforementioned problem, according to the embodiment of the present disclosure, another separate I/O wait queues 331, 332 may be used for the first type of I/O request and the second type of I/O request at the block layer 340. Specifically, on the basis of type of the I/O request (S331), the first type of I/O request is inserted into the first I/O wait queue 331, and the second type of I/O request may be inserted into the second I/O wait queue 332.

Further, in the present embodiment, the first I/O wait queue 331 and the second I/O wait queue 332 operate in a first-in first-out manner, and the I/O request inserted into the first I/O wait queue 331 may be processed with a higher priority. This makes it possible to prevent the scheduling of first type of I/O request from being delayed due to second type of I/O request in the block layer 330.

On the other hand, according to the above embodiment, a starvation in which the I/O request inserted into the second I/O wait queue 332 is not continuously processed may occur. In order to solve this problem, the I/O processing apparatus 100 may process the second type of I/O queue 332 inserted into the second I/O wait queue 332 at regular intervals or for each predetermined time interval, irrespective of the priority. That is, even when a first type of I/O request is present in the first I/O wait queue 331, if a predetermined time or cycle arrives, the I/O request inserted into the second I/O wait queue 332 may be dispatched to the storage device 340.

In some embodiments of the present disclosure, the number of second type of I/O requests to be dispatched from the second I/O queue 332 to the storage device 340 may be limited to a predetermined number or less. This is because contention may occur between the first type of I/O request and the second type of I/O request in accordance with the scheduling policy of the queue existing inside the storage device 340, and thus, the processing of the first type of I/O request may be delayed. That is, in the present embodiment, limitation of the number of second type of I/O request to be dispatched may be understood to be performed for reducing the probability that the I/O request is delayed by the second type of I/O request in the internal queue of the storage device 340.

The method for processing the first type of I/O request with high priority on the entire I/O path has been described with reference to FIGS. 9 to 10. Next, the method for processing I/O in consideration of the phenomenon of priority inversion will be described with reference to FIGS. 11 to 14B.

The phenomenon of the I/O priority inversion may be caused by the I/O dependency or the task dependency. The I/O dependency means a dependency which occurs between the first type of I/O request and the second type of I/O request. For example, when a write request to the same file is received during processing of the second type of write I/O to the file, the write request has no choice but to wait even in the case of the first type of I/O having a higher priority. Thus, a phenomenon of priority inversion in which the first type of I/O request is dependent on the second type of I/O request may occur frequently.

The task dependency means dependency which occurs between the tasks which concurrently access the critical section, using synchronization primitives such as mutex, condition variable, and semaphore. For example, if a background task acquires a synchronization primitive and enters the critical section, the foreground task needs to wait until the background task releases the synchronization primitive. Therefore, the phenomenon of priority inversion in which the foreground task depends on the background task may occur frequently.

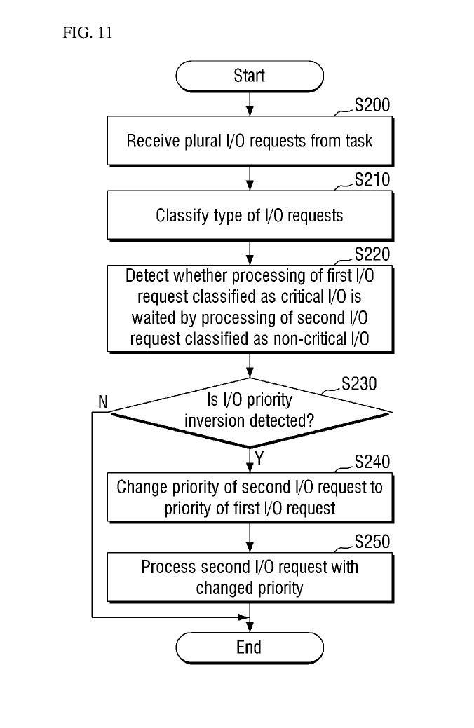

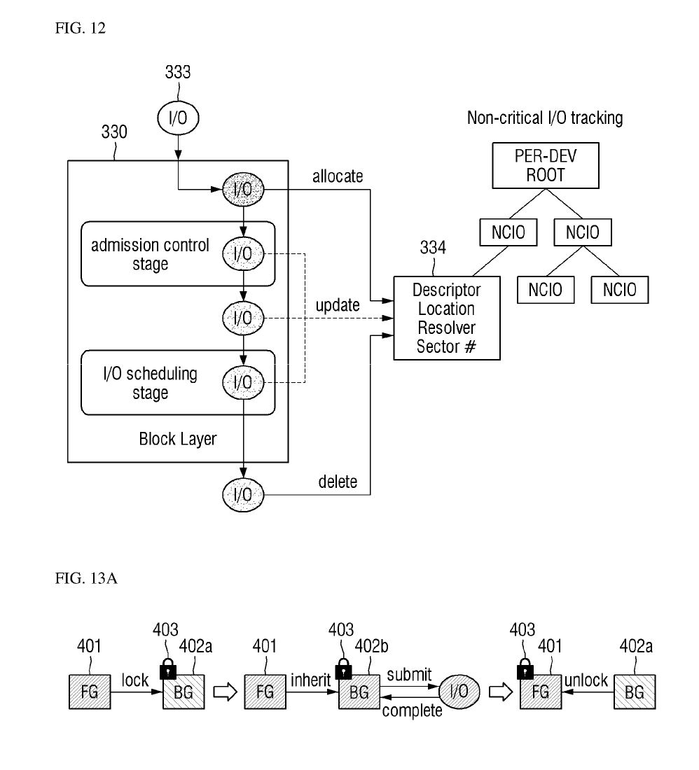

In order to solve the problem as described above, in some embodiments of the present disclosure, the duration of the phenomenon of priority inversion is minimized through the priority inheritance. Hereinafter, a method for processing the phenomenon of priority inversion according to the I/O dependency will be described with reference to FIGS. 11 and 12.

FIG. 11 is a flowchart of a method for processing the phenomenon of priority inversion according to the I/O dependency that can be referred to in some embodiments of the present disclosure.

Referring to FIG. 11, the I/O processing apparatus 100 classifies the type of I/O request received from the task into critical I/O or non-critical I/O (S200, and S210). Since the description of steps (S200, S210) is the same as that described above with reference to FIG. 7, the description will not be provided.

Next, the I/O processing apparatus 100 determines whether the processing state of the first I/O request classified as critical I/O is changed to the standby state due to the I/O dependency, that is, the phenomenon of I/O priority inversion occurs (S220). When the phenomenon of the I/O priority inversion is detected (S230), the I/O processing apparatus 100 changes the priority of the second I/O request of the non-critical I/O type which is in the I/O dependency relation with the first I/O request (S240). Specifically, the I/O processing apparatus 100 changes the priority of the second I/O request to the priority of the first I/O request. In accordance with the change of the priority, the type of the second I/O request is also changed to the critical I/O which is the type of the first I/O request.

Next, the I/O processing apparatus 100 quickly processes the second I/O request to the changed priority (S250). In this step (S250), since the rapid processing is executed on the second I/O request in accordance with the inherited priority, it is possible to prevent the processing of the first I/O request which is the critical I/O from being delayed by the phenomenon of the priority inversion.

The processing step (S250) of the second I/O request will be specifically described. In step (S250), the method for processing the second I/O request may change depending on the current processing position of the second I/O request.

For example, when the current processing position of the second I/O request is an admission control stage for determining whether to insert into the second I/O wait queue 332, the processing of the second I/O request can be performed in a manner of retrying inserting into the first I/O wait queue 331. Since the first I/O wait queue 331 is processed in preference to the second I/O wait queue 332, there is a high possibility that the first I/O wait queue 331 has a loading space. Therefore, when retrying inserting into the first I/O wait queue 331, the second I/O request can be processed immediately without waiting.

In another example, in the case of an I/O scheduling stage in which the current processing position of the second I/O request is inserted into the second I/O wait queue 332 and waits for dispatching to the storage device, the processing of the second I/O request may be performed in a manner of removing the second I/O request from the second I/O wait queue 332 and loading the second I/O request on the first I/O wait queue 331. When inserted into the first I/O wait queue 331, since processing is performed in preference to the second I/O wait queue 332, the second I/O request may be rapidly processed.

According to the aforementioned examples, since the processing method changes depending on the current processing position of the second I/O request, the current position information of the second I/O request needs to be managed. In addition, since the priority of the second I/O request is changed in accordance with the phenomenon of priority inversion, it is also necessary to manage information on the priority.

Therefore, according to the embodiment of the present disclosure, the I/O processing apparatus 100 can manage the metadata including the information of the second type of I/O request in the form of various data structures. This will be explained with reference to FIG. 12.

Referring to FIG. 12, when the I/O request 333 to be processed is a second type of I/O request, the I/O processing apparatus 100 may generate and manage metadata 334 of the I/O request 333. In FIG. 12, the metadata of the second type of I/O request is illustrated as an NCIO (Non-Critical I/O) object, and is illustrated to be managed by a tree format data structure (e.g., red black tree, B tree, B+tree etc.) for rapid searching. However, the data structure for managing the metadata can be managed with various data structures such as a hash table, in addition to the tree structure, and this may be changed depending on the embodiment.

Specifically, in the case where the type of I/O request 333 to be processed entering the block layer 330 is a non-critical I/O, the I/O processing apparatus 100 generates the metadata 334 corresponding to the I/O request 333 to be processed. At this time, the metadata may include information such as a descriptor of an I/O request, and a current processing location. The current processing position information in the metadata 334 is updated each time the processing position of the I/O request 333 to be processed is changed. For example, each time the processing position of the I/O request 333 to be processed is changed to an admission control stage of determining whether to be inserted into the second I/O wait queue 332, and an I/O scheduling stage of waiting at the second I/O wait queue 332, the current processing position information of the metadata 334 is updated to the changed position. Further, when the I/O request 333 to be processed is dispatched to the storage device and exceeds the block layer 330 or the type is changed to the critical I/O, the I/O processing apparatus 100 removes metadata 334 corresponding to the I/O request 333 to be processed.

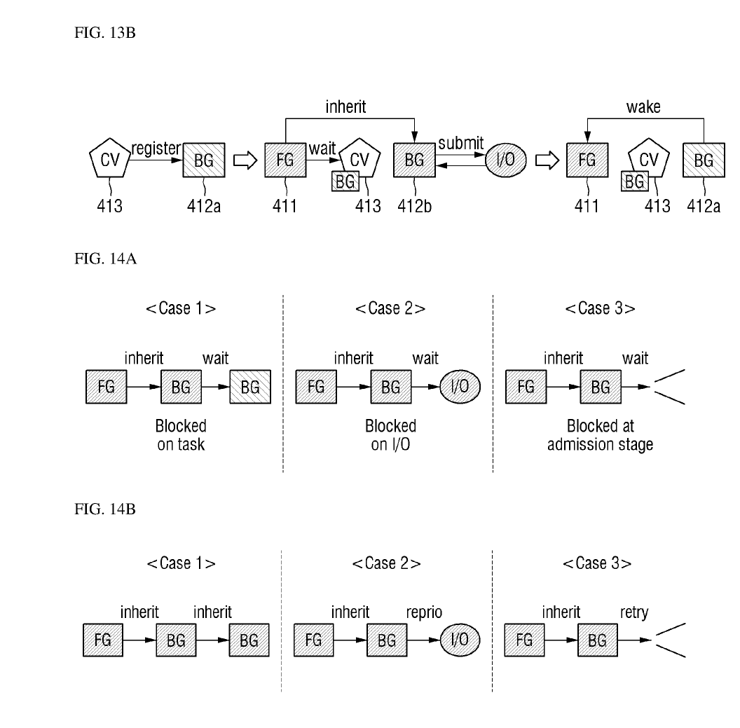

The method for processing the phenomenon of priority inversion according to the I/O dependency has been described above. Next, the method for processing the phenomenon of priority inversion according to the task dependency will also be described with reference to FIGS. 13A and 13B.

FIG. 13A is a diagram for explaining a task dependency caused by a mutex of synchronization primitive, and FIG. 13B is a diagram for explaining a task dependency caused by a condition variable of the synchronization primitive. In the following drawings, circular and rectangular figures indicate tasks, and circular figures indicate I/O.

First, referring to FIG. 13A, the phenomenon of priority inversion that occurs when the background task 402a acquires the mutex 403 to enter a specific critical section in the I/O region (e.g., file) and the foreground task 401 also tries to acquire the mutex 403 to enter the critical section is illustrated on the left side. In such a situation, since the priority of the background task 402a is lower than that of the foreground task 401, there is a high possibility that the processing of the I/O request of the background task is delayed. In addition, since the processing of the I/O request of the background task 402a needs to be completed in order that the background task 402a releases the mutex 403, there is a problem in which I/O processing of the foreground task 401 is delayed in accordance with the I/O processing delay of the background task 402a.

Therefore, according to the embodiment of the present disclosure, when the phenomenon of the I/O priority inversion is detected, the I/O processing apparatus 100 temporarily changes the priority of the background task 402a to the priority of the foreground task 401 that is waiting to acquire the mutex 403 (see the intermediate drawings of FIG. 14A). The priority of the changed background task 402b is maintained until the background task 402b releases the mutex 403. That is, when the mutex 403 is released, the priority of the background task 402a is returned to the original priority again. According to the present embodiment, I/O requested by the background task 402b can be processed quickly in accordance with the changed priority. Further, when the I/O processing is rapidly completed, since the background task 402b quickly releases the previously acquired mutex 403, the waiting time of the foreground task 401 waiting for acquisition of the mutex 403 can be minimized.

Next, a method for processing task dependency caused by a condition variable will be described with reference to FIG. 13B.

Referring to FIG. 13B, like the mutex, the foreground task 411 is waiting via the condition variable 413 until it receives the wake signal 413, and when the task which sends the wake signal is the background task 412a, the phenomenon of the I/O priority inversion according to the task dependency occurs.

According to the embodiment of the present disclosure, when the phenomenon of the I/O priority inversion is detected, the I/O processing apparatus 100 changes the priority of the background task 412a scheduled to send the wake signal to the priority of the waiting foreground task 411, and quickly processes the I/O processing of the background task 412b in accordance with the changed priority. Further, when the background task 412b sends the wake signal, the I/O processing apparatus 100 performs processing so that the priority of the background task 412b is returned to its original priority again. As a result, the time at which processing of the foreground task 411 is delayed due to the background task 412a can be minimized.

For reference, because the owner of the condition variable cannot know the background task that sends the wake signal, unlike the certain mutex, there is a problem in which it is accurately determine the background task which is a target of priority change. Therefore, according to the embodiment of the present disclosure, it is possible to determine the background task having the history of sending the wake signal to the foreground task as the task of the target of the priority change. This is based on the discovery that the background task that shares the critical section with the foreground task is generally limited and the background task experienced in sending the wake signal is highly likely to send the wake signal again. In the present embodiment, when there are many background tasks experienced in sending the wake signal, the background task which is the target of priority change can be determined in consideration of the cumulative transmission number of times of the wake signal of each background task, the number of times of recent transmissions, and the like.

The method for processing the phenomenon of priority inversion according to the task dependency has been explained above. Next, a method for processing the phenomenon of priority inversion according to a transitive dependency, which indicates the case where the task dependency or the I/O dependency occurs will be described referring to FIGS. 14A and 14B.

The task dependency and the I/O dependency described above may be generated continuously over a plurality of tasks or a plurality of I/O requests. For example, a task dependency may occur between the foreground task and the first background task, and another task dependency may occur between the first background task and the second background task.

Referring to FIG. 14A, the transitive dependency may be largely abstracted to three cases. A first case is a case where the task dependency occurs consecutively. A second case is a case where the task dependency and the I/O continuity occur consecutively. For example, there may be a case where the task dependency occurs between the foreground task and the background task, and the I/O request of the background task is blocked by another second type of I/O request and waits. A third case is a case where the I/O request of the background task that is dependent on the foreground task is waiting at any one admission control stage among the admission control stages present on the I/O path. For example, this case means a case where the I/O request of the background task is waiting at the admission control stage of the caching layer to receive allocation of the buffer page, or waiting at the admission control stage of the block layer so as to be inserted into the I/O wait queue.

Referring to FIG. 14B, when the first case and the second case occur, the I/O processing apparatus 100 may successively execute the priority inheritance to solve the transitive dependency. For example, the I/O processing apparatus 100 may process the priority of the foreground task so as to be inherited up to the last background task or up to the last I/O request in the first case or the second case, thereby solving the transitive dependency.

In the case of the third case, the I/O processing apparatus 100 may solve the transition dependency in a manner of retrying the I/O request of the background task in accordance with the changed priority. For example, according to the above-described example, different threshold values are applied depending on the type of I/O request in the admission control stage of the caching layer. Accordingly, it is possible to solve the waiting problem at the admission control stage by retrying the admission request to the changed type in accordance with the priority inheritance.

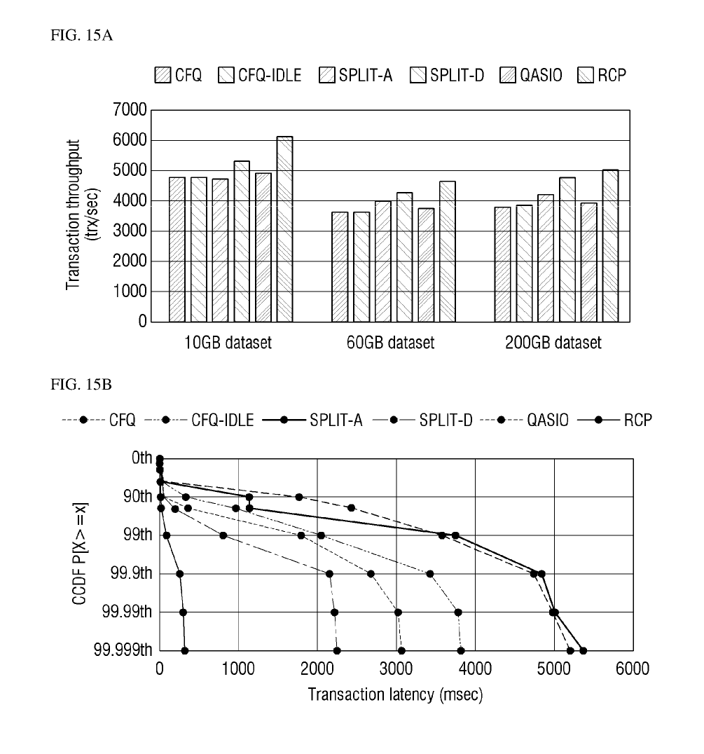

The method for processing I/O according to the embodiment of the present disclosure has been described with reference to FIGS. 7 to 14B. Hereinafter, with reference to FIGS. 15A to 15B, results obtained by performing comparative experiments between the above-described method for processing I/O and the conventional technique in terms of throughput and response time will be briefly described.

FIG. 15A illustrates a graph obtained by performing comparative experiments between the method for processing I/O according to the embodiment of the present disclosure and the throughput of the conventional I/O scheduler. In the graph illustrated in FIG. 15A, an x-axis refers to the scale of the data, and a y-axis refers to the number of client requests processed per seconds.

In FIG. 15A, RCP refers to the experimental result according to the above-mentioned method for processing I/O, CFQ-IDLE refers to a case where the checkpoint task is executed with low priority and CFQ (Completely Fair Queuing) is operated, and SPLIT-A and SPLIT-D refer to Split-AFQ and Split-Deadline, respectively.

According to the experimental result illustrated in FIG. 15A, when processing the I/O request of the foreground task in accordance with the method for processing I/O according to the embodiment of the present disclosure, the throughput improvement effect of about 30% or more was found as compared with the CFQ which is the basic I/O scheduler of Linux. Moreover, it was found that the throughput is improved even compared with any I/O scheduler other than CFQ.

Next, FIG. 15B illustrates a graph obtained by performing comparative experiments between the method for processing I/O according to the embodiment of the present disclosure and the response time of the conventional I/O scheduler. In the graph illustrated in FIG. 15B, the x-axis refers to the response delay time, and y-axis refers to CCDF (complementary cumulative distribution function).

According to the experimental result illustrated in FIG. 15B, in the case of processing the I/O request of the foreground task in accordance with the method for processing I/O according to the embodiment of the present disclosure, it was found that most client requests are processed within 300 ms. This illustrates that the response delay is greatly improved as compared with the case where the response delay time of the I/O scheduler according to the related art is 2 seconds.

In summary, according to the graphs illustrated in FIGS. 15A to 15B, when processing the client requests, using the method for processing I/O according to the embodiment of the present disclosure, it was found that the not only the response delay time as well as the throughput are greatly improved as compared with the related art.

The method for processing I/O according to the embodiment of the present disclosure described with reference to FIGS. 7 to 15B was explained on the assumption that the received client requests from a plurality of client terminals are processed in a single I/O processing apparatus 100 or the I/O processing module 111. A method for processing client requests according to still another embodiment of the present disclosure for processing client requests in a cluster system including a plurality of I/O processing apparatuses or a plurality of I/O processing modules will be described below.

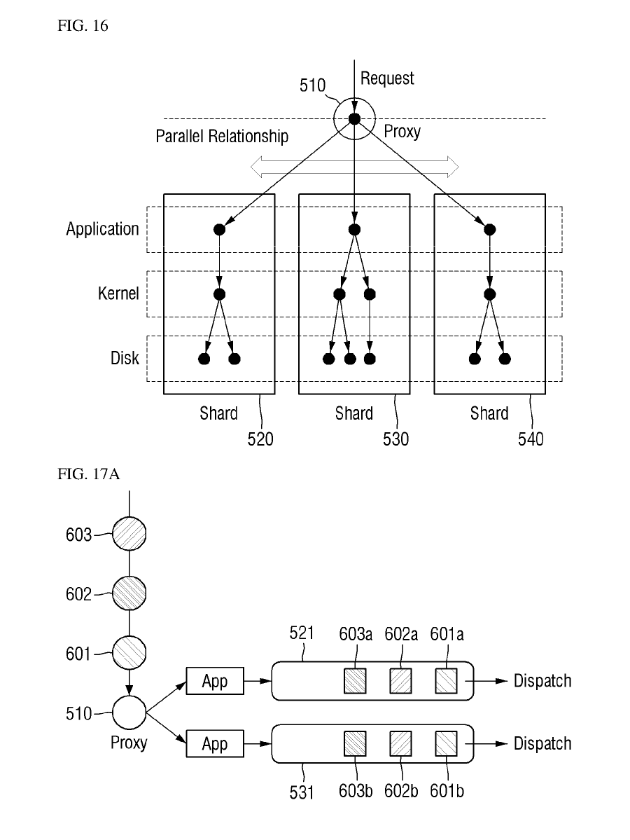

FIG. 16 illustrates an exemplary cluster system capable of executing a method for processing client requests according to still another embodiment of the present disclosure.

Referring to FIG. 16, the exemplary cluster system may include a proxy 510 and a plurality of nodes 520, 530, 540. The exemplary cluster system may be, for example, a DB cluster system in which data is duplicated or distributed in a plurality of DB servers.

In the exemplary cluster system, the proxy 510 receives client requests including a query on predetermined data from a client terminal (not illustrated), and transfers the client requests to the appropriate node. At this time, the client requests may be divided and processed into at least one sub-request in order to improve the response speed. For example, in the case where data is duplicated on two DB servers to construct a DB cluster in order to secure high availability in the DB cluster system, one client requests is divided into two sub-requests, and is transferred to each DB server.

In the exemplary cluster system, the plurality of nodes 520, 530, 540 may be constituted as various types of scale-out structures. For example, as illustrated in FIG. 16, the nodes may be constituted as a horizontal division structure (e.g., sharding) and may be constituted as a vertical division structure, which may be different depending on the embodiments.

In the exemplary cluster system, each node 520, 530, 540 may be, for example, the I/O processing apparatus or the I/O processing module as described above. Therefore, each node 520, 530, 540 processes the sub-request transmitted from the proxy 510 as a foreground task having a high priority, and the I/O request issued by the foreground task may be maintained on the whole output path to be processed with high priority.

For reference, each node 520, 530, 540 and the proxy 510 may be provided in the form of a physical node such as an independent server device in accordance with the embodiment, and may be provided in the form of a logical node such as a virtual machine.

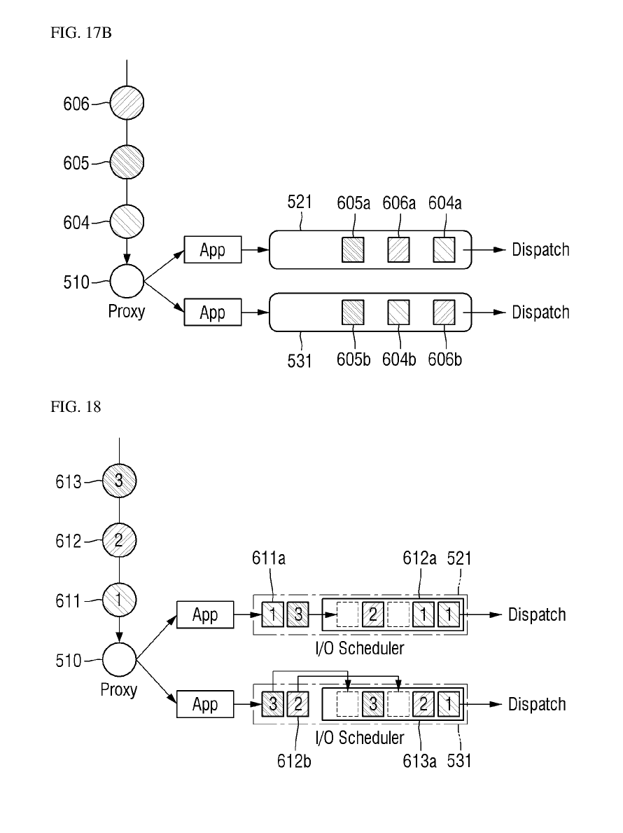

Hereinafter, a brief explanation will be given of a problem of response delay occurring when the client requests are processed in the cluster system with reference to FIGS. 17A and 17B.

In the cluster system, since each node processes sub-requests without information on the processing order of client requests, the processing order of the client requests may not be ensured. Furthermore, a case where the arrival order is changed in the course that the sub-requests are sent to each node in the proxy, or a case where the processing order of I/O requests is changed in the course of I/O requests derived from sub-requests may frequently occur. Accordingly, the average response time of the entire client requests in the cluster system may not be ensured and the processing of some client requests may be significantly delayed. In particular, in the cluster system, since the processing of the sub-request derived to each node from the cluster system needs to be completed in order to complete processing of the client request, there is a high possibility that the processing of some client requests is delayed.

To provide a better understanding, the problem of average response delay in the example cluster system illustrated in FIGS. 17A and 17B will be described. In FIGS. 17A and 17B, it is assumed that the proxy 510 receives three client requests, each client requests is divided into two sub-requests, and the client requests is transferred only to two nodes 520, 530. Also, it is assumed that one I/O request is issued for each sub-request to process the sub-request, and that the processing order of the client requests is the same as the received order.

FIG. 17A illustrates an ideal case where the average response delay is minimized. That is, as illustrated in FIG. 17A, when processing at each node 520, 530 is completed in order of client requests (601 to 603), the average response delay may be minimized. However, as described above, since each node does not know the processing order of client requests, the case illustrated in FIG. 17A may not be ensured.

For example, in some cases, the processing order of the I/O request may be changed as illustrated in FIG. 17B. As described above, this may occur due to various causes, such as a change in the arrival order of the sub-requests, and a change in the processing order of the I/O requests. In the case illustrated in FIG. 17B, the first client request 604, which is the first sequence, is handled first at the first node 520, but is processed to be later than the third client requests 606 which is the last order at the second node 530. In such a case, since the response to the first client request 604 is executed after the processing of the I/O request 604b is completed at the second node 530, the response to the first client request 604 is delayed. Also, because the second client request 605 which is the second order is processed last at both the first node 520 and the second node 530, the response to the second client request 605 is also delayed. Consequently, in the case illustrated in FIG. 17B, the average response time of the entire client requests is delayed.

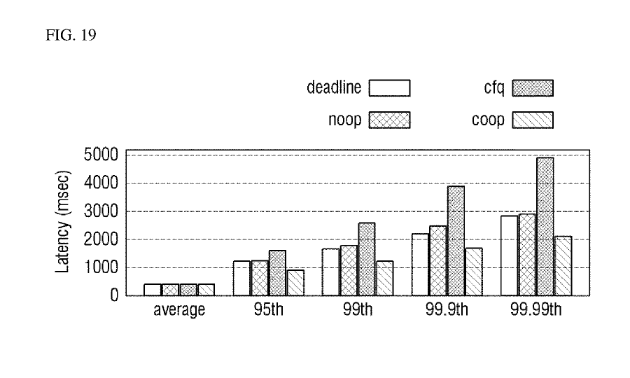

Hereinafter, a method for processing client requests according to an embodiment of the present disclosure for solving the above-described response delay problem will be described with reference to FIG. 18.

The above-mentioned problem may be understood to occur since each node performs the processing without knowing that each sub-request is derived from which client requests in a state where the sub-requests are mixed. Therefore, according to the embodiment of the present disclosure, as illustrated in FIG. 18, a request identifier is allocated from the proxy 510 in accordance with the processing order of the client requests 611, 612, 613. For example, in the case of the first client request 611 which is the first processing order, a request identifier corresponding to “1” is assigned, and in the case of the second client request 612 which is the second processing procedure, a request identifier corresponding to “2” is assigned.

In an embodiment, the request identifier may be assigned in accordance with the order in which client requests are received to the proxy 510. That is, the processing order of each client requests may be determined, using the time stamp of the proxy 510 in which the client requests is received.

In another embodiment, the request identifier may be assigned in the order in which the client terminal sends the client requests. For example, the request identifier may be assigned in accordance with the time stamp of the transmission time of the client terminal. According to the present embodiment, there is an advantage that, even when the order of the client requests is changed on the transmission path, the processing order can be accurately determined on the basis of the transmission time.

The request identifier allocated in accordance with the above-described embodiment is inherited by the sub-request and the I/O request. That is, as illustrated in FIG. 18, each I/O request has the same identifier as the request identifier of the client request. Further, each I/O processing apparatus performs the I/O scheduling on the basis of the identifier assigned to the I/O request. Therefore, the processing order of the client requests can be ensured on the I/O path of each node, and the derived plural sub-requests are processed at each node in accordance with the processing order of the client requests. Thus, the average response speed can be improved.

Specifically, each node that has received the sub-request performs the I/O scheduling on the basis of the identifier of the I/O request assigned in accordance with the request identifier of the client request. For example, as illustrated in FIG. 18, in order to preferentially process the I/O request 611a of the first client request 611, the first node 520 performs reordering which inserts the I/O request 611a before the I/O request 612a of the second client request 612 in the I/O wait queue 511. In another example, in order to process the I/O request 612b of the second client request 612 before the third client request 613, the second node 530 performs reordering which inserts the I/O request 612a before the I/O request 613a of the third client request 613 in the I/O wait queue 521. By performing the I/O scheduling in this way, the I/O requests generated in accordance with the sub-request can be processed in accordance with the processing order assigned to the client requests at each node.

On the other hand, in addition to the I/O request related to an actual client request, a read ahead request voluntarily issued by the operating system may be included in the I/O requests issued in response to the sub-request. The read ahead request sends the request to predict the future and read in advance in a case where the read I/O request is processed for the continuous I/O region, and the read ahead request is an I/O request that is executed as a supplement to improve the performance.

However, when the read ahead request inherits the same request identifier as that of the I/O request according to the client request, in some cases, processing of the I/O request according to the client requests may be delayed due to the processing of the read ahead request. Therefore, according to the embodiment of the present disclosure, the read ahead request may be processed such that an identifier corresponding to a later order than the I/O request according to the client requests is assigned. According to the present embodiment, since the I/O request according to the client requests is preferentially processed, and the read ahead request is processed at the idle time, the response delay of the client requests can be minimized.

Also, according to the embodiment of the present disclosure described above, it is possible to improve the average response time by sequentially processing a plurality of client requests in accordance with the processing order specified by the proxy 510. However, in the case where there is a client request that generates a large I/O amount, there may be a problem in which the average response time is delayed. For example, when a first client request for generating a large I/O amount is processed at a first rank, and a second client request and a third client requests are processed at a third rank and a third rank, processing of the second and third client requests may be greatly delayed due to I/O request processing according to the first client request, and in such a case, the average response time is delayed.

In order to solve the aforementioned problem, according to another embodiment of the present disclosure, selective I/O scheduling may be executed on the basis of the I/O amount generated in accordance with the client requests. For example, when the I/O amount generated in accordance with the first client request is less than the threshold value, the I/O request generated in accordance with the first client request may be reordered in the I/O wait queue in accordance with the processing order. However, when the I/O amount generated in accordance with the second client request is equal to or larger than the threshold value, the I/O request generated in accordance with the second client request is not reordered, and may be processed to be inserted at the end of the I/O wait queue. Or, according to an embodiment, a request identifier may be assigned so that the processing order of the second client request is a rear rank.

In this embodiment, the above threshold value may be a variable value which is dynamically changed in accordance with the monitoring result of I/O amount for each client request. For example, after monitoring the I/O amount for each client requests and obtaining a normal distribution according to the I/O amount, an I/O amount corresponding to the upper n percent previously specified in the normal distribution may be determined as the threshold value.

Some embodiments of the present disclosure described above have been described focusing on the scheduling of I/O wait queue for dispatching I/O requests to the storage device. However, since the I/O request dispatched to the storage device is scheduled again in the internal queue of the device existing inside the storage device, in some cases, the effect of the I/O scheduling according to the above-described embodiment may be lowered. For example, when the firmware inside the storage device processes the I/O request for improving the efficiency of the device I/O, the effect of the I/O scheduling according to the above-described embodiments may be lowered.

In order to solve the aforementioned problem, in an embodiment of the present disclosure, the size of the queue inside the storage device may be set to 1. When the size of the internal queue of the storage device is 1, the order of the I/O requests dispatched by the I/O scheduling may be maintained as it is in the storage device. According to this embodiment, although the processing order of the I/O request may be maintained by a simple method, since the parallelism inside the storage device is not utilized, there may be a problem in which the throughput of the storage device is lowered.

In another embodiment of the present disclosure, in order not to limit the throughput of the storage device, the size of the internal queue of the storage device is not limited, and the number of I/O requests to be dispatched to the storage device may be limited. For example, the number of I/O requests may be dynamically limited on the basis of at least one of the type of storage device (e.g., HDD, SSD, and NVMe SSD), the type of I/O request (e.g., read, and write) and the size of the I/O data. In a more specific example, when the type of storage device is an HDD, the number of I/O requests may be limited so that a smaller number of I/O requests than SDD is dispatched, and when there are many write type I/O requests, or there are many I/O requests with large data sizes, the number of I/O requests may be limited so that fewer I/O requests are dispatched. According to this embodiment, it is possible to alleviate the problem of deterioration of the I/O scheduling effect due to the internal queuing of the storage device, while securing the maximum throughput of the storage device.

The method for processing the client requests for improving the average response delay of many client requests in the cluster system has been described above referring to FIGS. 16 to 18. Hereinafter, the result of comparative experiments between the method for processing the client requests and the related art in terms of response time will be briefly described referring to FIG. 19.

Next, FIG. 19 illustrates a graph of comparative experiments between the method for processing client requests according to an embodiment of the present disclosure and a response time of a conventional I/O scheduler. In the graph illustrated in FIG. 19, “average” represents an average response delay, and the remaining portion represents tail latency. In addition, MongoDB is used to construct a cluster system, each node in the cluster is built as a virtual machine, noop, deadline, CFQ refer to the I/O scheduler provided by Linux, and coop refers to the method for processing the client request.

According to the experimental result illustrated in FIG. 19, when the client requests are processed in the cluster system in accordance with the processing of the client requests according to the embodiment of the disclosure, it appears that the average response delay is slightly improved, and in particular, the tail latency that greatly affects the user's perceived performance is greatly improved as compared to the conventional I/O scheduler. Therefore, it is expected that when the method for processing client requests is applied to a game service or the like sensitive to response delay according to an embodiment of the present disclosure, an improved user experience can be provided to the end user.

The concepts of the disclosure described above with reference to FIGS. 5A to 19 can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present subject matter. Therefore, the disclosed preferred embodiments are used in a generic and descriptive sense only and not for purposes of limitation.

What is claimed is:

1. A method for processing client request executed in a cluster system including a plurality of nodes, the method comprising:
tagging a request identifier to the client request in accordance with a processing order of the client request in response to receiving the client request;
forwarding a first sub-request derived from the client request to a first node of the plurality of nodes, and forwarding a second sub-request derived from the client request to a second node of the plurality of nodes, the request identifier being tagged to each of the first sub-request and the second sub-request;
processing a first I/O request generated in accordance with the first sub-request, depending on the processing order of the request identifier tagged to the first sub-request, at the first node; and
processing a second I/O request generated in accordance with the second sub-request, depending on the processing order of the request identifier tagged to the second sub-request, at the second node.

2. The method for processing client requests of claim 1, wherein the request identifier is generated on the basis of a transmission time stamp of a client terminal side which transmits the client request.

3. The method for processing client requests of claim 1, wherein the processing the first I/O request comprises:
determining whether a rear rank I/O request generated in accordance with a third sub-request exists in an I/O wait queue of the first node, the third sub-request being a sub-request in which a request identifier with later processing order than the first sub-request is tagged, and
inserting the first I/O request before a position where the rear rank I/O request at the I/O wait queue of the first node, in response to the determining that the rear rank I/O request exists.

4. The method for processing client requests of claim 1, wherein the first I/O request comprises an I/O request generated in accordance with a read ahead, and an I/O request irrelevant to the read ahead, and
wherein the processing the first I/O request comprises:
processing the I/O request generated in accordance with the read ahead in a rear rank than the processing order of the request identifier tagged to the first sub-request; and
processing the I/O request irrelevant to the read ahead in accordance with the processing order of the request identifier tagged to the first sub-request.

5. The method for processing client requests of claim 1, wherein the processing the first I/O request comprises:
determining whether an I/O amount of the first I/O request is greater than or equal to a threshold value; and
processing the first I/O request depending on the processing order of the request identifier tagged to the first sub-request, in response to the determining that the I/O amount is less than the threshold value.

6. The method for processing client requests of claim 5, wherein the threshold value is determined on the basis of distribution of I/O amount for each sub-request forwarded to the first node.

7. The method for processing client requests of claim 1, wherein the processing the first I/O request comprises inserting the first I/O request into an I/O wait queue of the first node, and dispatching the inserted first I/O request to a storage device,
wherein a number of I/O requests to be dispatched from the I/O wait queue to the storage device for a predetermined period is limited to a predetermined number or less.

8. The method for processing client requests of claim 7, wherein the number is determined depending on any one factor among a type of storage device, a proportion of write I/O request occupied in dispatched I/O requests, and a size of I/O data of I/O request to be dispatched.
